(19) United States
(12) Patent Application Publication
(10) Pub. No.: US 2024/0367198 A1
(43) Pub. Date: Nov. 7, 2024

(54) SYSTEMS AND METHODS FOR DOUBLE SHIFTER SORTING

(71) Applicant: MARTISTEL INNOVATION FZCO, Dubai (AE)

(72) Inventors: Oleg Sultanov, Dubai (AE); Sergey Razumov, Dubai (AE); Andrei Zaretckii, Dubai (AE)

(21) Appl. No.: 18/312,273

(22) Filed: May 4, 2023

(51) Int. Cl. B07C 1/18; B65G 1/127

(52) U.S. Cl. CPC B07C 1/18; B65G 1/127

(57) ABSTRACT

Systems and methods for sorting a vertically-stored stack of boxes. A system includes a lifter subassembly including a lifting frame defining a first aperture and a second aperture, a set of vertical rails coupled to the lifting frame, and a drive mechanism coupled to the lifting frame and the set of vertical rails to drive the lifter frame along at least one of the set of vertical rails, and a shifter subassembly including a set of horizontal rails positioned proximate the lifting frame, and a shuttle robot to transport the stack of boxes along the plurality of horizontal rails between the first aperture and the second aperture.

### TECHNICAL FIELD

Embodiments relate generally to vertical storage systems. More particularly, embodiments relate to systems and methods for optimizing stacked vertical storage.

### BACKGROUND

Traditional warehouse operations include the handling and storage of products in order to receive inventory, store inventory, collect inventory from different containers to prepare orders, and ship orders to customers. In systems of vertical or stacked storage, goods are typically stored in boxes, which can be stacked. It is desirable to access a target box stored in a stack using a minimum number of actions and in a minimum amount of time.

A technical problem arises in how to efficiently access a target box stored in a stack. For example, to access a target box that is not the top box in a stack, it is inefficient to sequentially remove each box above the target box in order to access the goods in the target box. Another related technical problem arises when space around the stacks is at a premium. For example, certain warehouse environments have minimal space above the stacks. It is often impractical or even impossible to remove all boxes above a target box and place the removed boxes high above or around the stack during the target box access operations.

Accordingly, stack access operations must be carried out as quickly and efficiently as possible, while not exceeding the standards of storage of goods and corresponding to the accuracy of positioning boxes and stacks. Therefore, there is a need for systems and methods that can efficiently access target boxes in stacked vertical storage.

### SUMMARY

Embodiments described herein or otherwise contemplated herein substantially meet the aforementioned needs of the industry. Systems and methods of a double shifter sorting system can capture one or several boxes in a given stack at a time and rearrange the captured boxes using at least one shuttle robot that can move in two directions.

In an embodiment, a system for sorting a vertically-stored stack of boxes includes a lifter subassembly including a lifting frame defining a first aperture and a second aperture, each of first aperture and the second aperture configured to temporarily couple to a box in the stack of boxes, a plurality of vertical rails operably coupled to the lifting frame, and a drive mechanism operably coupled to the lifting frame and the plurality of vertical rails and configured to drive the lifter frame along at least one of the plurality of vertical rails, and a shifter subassembly including a plurality of horizontal rails positioned proximate the lifting frame, and a shuttle robot configured to transport the stack of boxes along the plurality of horizontal rails between the first aperture and the second aperture.

In another aspect, when at least one box is temporarily coupled to the first aperture, the drive mechanism is further configured to raise the lifting frame above a remaining stack of boxes underneath the lifting frame, and the shuttle robot is further configured to transport the remaining stack of boxes underneath the lifting frame to proximate the second aperture.

In another aspect, a first box in the stack of boxes is temporarily coupled to the first aperture while a second box in the stack of boxes is temporarily coupled to the second aperture.

In another aspect, each box in the stack of boxes comprises a ledge that projects horizontally from a body of the box, wherein the lifting frame is configured to temporarily couple to the box using the ledge.

In another aspect, the lifting frame further comprises a clamp, and the lifting frame is further configured to temporarily couple to the box using the clamp.

In another aspect, a system further includes a processor and a memory operably coupled to the processor and a control logic engine executed by the processor and configured to sort the stack by lifting a first box immediately above a target box from the stack using the first aperture, the stack without the first box creating a first remaining stack, shifting the first remaining stack to proximate the second aperture using the shuttle robot, lifting the target box from the first remaining stack using the second aperture, the first remaining stack without the target box creating a second remaining stack, shifting the second remaining stack to proximate the first aperture, releasing the first box onto the second remaining stack, the first box added to the second remaining stack creating a third remaining stack, shifting the third remaining stack to proximate the second aperture, and releasing the target box onto the third remaining stack, the target box added to the third remaining stack creating a sorted stack.

In another aspect, the control logic engine is further configured to raise the lifting frame above a stack height to allow the shuttle robot to shift the first remaining stack, shift the second remaining stack, and shift the third remaining stack underneath the lifting frame.

In another aspect, the lifting frame is raised above the stack height at a minimum distance to avoid physical contact with the lifting frame and the first remaining stack, the second remaining stack, or the third remaining stack.

In another aspect, at least one of the plurality of vertical rails includes at least one groove for the drive mechanism to temporarily lock the lifter frame in place.

In another aspect, a system further includes an interface engine executed by the processor and configured to receive a sorting instruction from a warehouse computing device.

In an embodiment, a method of sorting a vertically-stored stack of boxes includes lifting a first box immediately above a target box from the stack of boxes using a first aperture of a lifting frame, the stack without the first box creating a first remaining stack, shifting the first remaining stack to proximate a second aperture of the lifting frame using a shuttle robot, lifting the target box from the first remaining stack using the second aperture, the first remaining stack without the target box creating a second remaining stack, shifting the second remaining stack to proximate the first aperture, releasing the first box onto the second remaining stack, the first box added to the second remaining stack creating a third remaining stack, shifting the third remaining stack to proximate the second aperture and releasing the target box onto the third remaining stack, the target box added to the third remaining stack creating a sorted stack.

In another aspect, lifting comprises driving the lifter frame along at least one of a plurality of vertical rails using a drive mechanism.

In another aspect, at least one of the plurality of vertical rails includes at least one groove for the drive mechanism, the method further comprising temporarily locking the lifter frame in place using the at least one groove.

In another aspect, shifting comprises transporting at least one box along a plurality of horizontal rails between the first aperture and the second aperture with the shuttle robot.

In another aspect, a method further includes raising the lifting frame above a stack height to allow the shuttle robot to shift the first remaining stack, shift the second remaining stack, and shift the third remaining stack underneath the lifting frame.

In another aspect, the lifting frame is raised above the stack height at a minimum distance to avoid physical contact with the lifting frame and the first remaining stack, the second remaining stack, or the third remaining stack.

In another aspect, a method further comprises receiving a sorting instruction from a warehouse computing device.

In another aspect, each box in the stack of boxes comprises a ledge that projects horizontally from a body of the box, the method further comprising temporarily coupling the lifting frame to the box using the ledge.

In another aspect, the lifting frame further comprises a clamp, the method further comprising temporarily coupling the lifting frame to the box using the ledge.

In another aspect, lifting a first box immediately above a target box further includes lifting at least one additional box on top of the first box

In a feature and advantage of embodiments, systems and methods utilize minimal additional space to operate. For example, stacks can be manipulated to access a target stack with very limited additional space surrounding the stack. Accordingly, stacks can be created and sorted to fill the maximum volume of a warehouse without wasting valuable warehouse space.

In another feature and advantage of embodiments, systems and methods can manipulate stacks in an efficient manner. For example, a minimal amount of time is needed to access a target box that is not the top box on a stack. More specifically, embodiments increase the speed of assembly of orders or delivery of a certain box in stacking storage systems.

In another feature and advantage of embodiments, systems and methods require a minimal set of drives (for example, one drive associated with one lifting frame). Advantageously, systems described herein are robust, leading to less maintenance and down time.

In another feature and advantage of embodiments, a double shifter sorting system includes a box grabber configured to temporarily couple to one or more boxes. A box grabber can include a frame having retractable grippers. For example, the retractable grippers can utilize vacuum or mechanical coupling to a box. Systems and methods can slideably position the frame at a particular level of a target box.

In another feature and advantage of embodiments, a double shifter sorting system includes vertical rails to lift or otherwise shift the box grabber frame. Accordingly, when the box grabber frame is engaged with a box, the engaged box (as well as all boxes on top of the engaged box) can be lifted off the stack.

In another feature and advantage of embodiments, a double shifter sorting system includes a gear or belt drive operably coupled to the box grabber frame and at least one vertical rail. For example, using the mechanical coupling by gear or drive belt to at least one vertical rail, the box grabber frame can be raised or lowered.

In another feature and advantage of embodiments, a double shifter sorting system includes a shifter subassembly including a shuttle robot configured to move a stack to a lifter subassembly positioned along a horizontal rail. The shuttle robot can further shift the stack between at least two sections of the lifter.

In another feature and advantage of embodiments, a double shifter sorting system provides a combined sorter and picker configured to access goods in a target box in a stack. For example, a lifter subassembly in coordination with a shifter subassembly can be utilized for changing the order of boxes in a stack and picking a given box.

In another feature and advantage of embodiments two different stacks can be sorted at a single double shifter sorting system. For example, a first stack and a second stack can be sorted according to different parameters, such as popular requests for a given product. Desired boxes containing those products can be sorted above the rest of the boxes in both first stack and second stack. The double shifter sorting system can utilize positions proximate to the lifter frame to temporarily store stacks that are in process of sorting in addition to the positions presented by the lifter frame and the positions presented by the shuttle robot.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures, in which:

FIG. 1 is a perspective view of a double shifter sorting system, according to an embodiment.

FIG. 2 is a block diagram of a warehouse management system, according to an embodiment.

FIGS. 3A-3F are block diagrams of a stack sorted by a double shifter sorting system, according to an embodiment.

FIG. 4 is a flowchart of a method for sorting by a double shifter sorting system, according to an embodiment.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION OF THE DRAWINGS

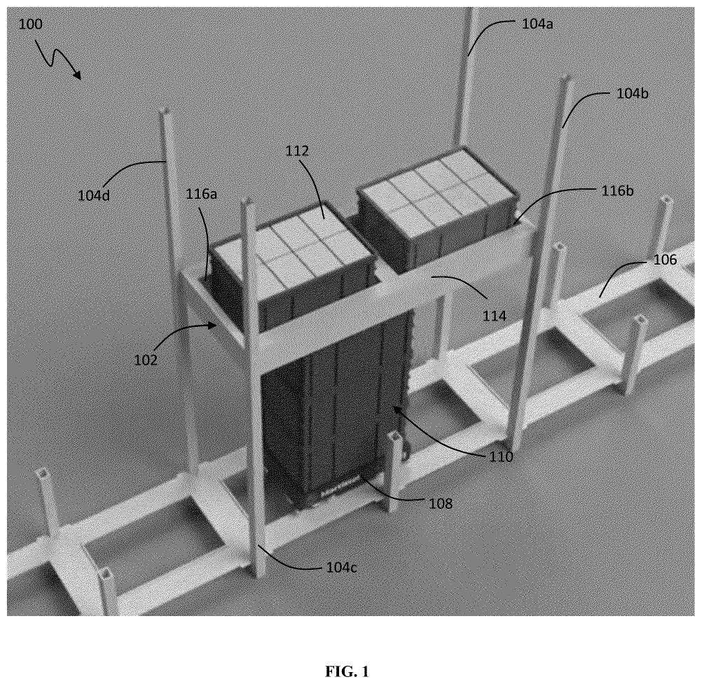

Referring to FIG. 1, a perspective view of a double shifter sorting system 100 is depicted, according to an embodiment. Double shifter sorting system 100 generally comprises a lifter frame 102, a plurality of vertical rails 104, a plurality of horizontal rails 106, and a shuttle robot 108. Double shifter sorting system 100 is configured to manipulate stack 110, and particularly, a plurality of boxes 112 in stack 110.

In certain embodiments, stack 110 comprises a vertical array of plurality of boxes 112. Each of plurality of boxes 112 can be a same size or can be different sizes. For example, each of plurality of boxes 112 can be a standard size or multiples (e.g. in height) of the standard size. In other embodiments, each of plurality of boxes 112 can be of many different sizes. For example, the bases of boxes 112 can be the same, but the height of certain dimensions may differ for different types of cargo. In an embodiment, each of plurality of boxes 112 can include a lip, ledge, or drop-down latch that projects horizontally from the rest of the box structure. The lip can project along the entire exterior of the box structure, or along selective portions such that the lip can engage with lifter frame 102. When stacked, each of plurality of boxes 112 are fixed in stack 110 relative to each other.

Lifter frame 102 comprises a generally rectangular base 114 including at least two apertures 116a and 116b. Rectangular base 114 comprises a border member that creates apertures 116a and 116b. In an embodiment, apertures 116a and 116b are generally rectangular and sized to receive plurality of boxes 112. When lifter frame 102 is operably coupled to one or more boxes 112, the engaged box can be lifted or raised vertically from stack 110. In embodiments, lifter frame 102 acts as a tray or table to support one or more boxes 112. For example, when a particular box is engaged with lifter frame 102, all additional boxes on top of the particular box engaged with lifter frame 102 are also lifted. This allows efficient access to a target box within a stack.

In an embodiment, lifter frame 102 can further comprise a clamp for temporarily further grabbing one or more boxes. In embodiments, any other suitable releasable coupling can be utilized.

Plurality of vertical rails 104a, 104b, 104c, and 104d each comprise a bar projecting substantially transverse to plurality of horizontal rails 106. Plurality of vertical rails 104 are respectively positioned to support lifter frame 102. For example, plurality of vertical rails 104a, 104b, 104c, and 104d are each positioned at a relative corner of lifter frame 102. In other embodiments, though not depicted, double shifter sorting system 100 comprises fewer vertical rails 104 can be utilized (e.g. one to three). In embodiments, double shifter sorting system 100 comprises additional vertical rails 104 (e.g. five to eight). In an embodiment, at least one of plurality of vertical rails 104 includes grooves or notches along the length of rail 104 to provide a locking position for lifter frame 102.

Though not depicted in FIG. 1, double shifter sorting system 100 further comprises a gear or belt drive. For example, a drive mechanism can be operably coupled with lifter frame 102 and at least one of plurality of vertical rails 104 to drive lifter frame 102 along at least one of plurality of vertical rails 104. Accordingly, lifter frame 102 is raised or lowered relative to plurality of vertical rails 104. In an embodiment, lifter frame 102 can therefore be slidably coupled to plurality of vertical rails 104. In embodiments, double shifter sorting system 100 can comprise a plurality of drive mechanisms to drive lifter frame 102 along at least two of plurality of vertical rails 104.

Plurality of horizontal rails 106 comprises a rail subsystem on which shuttle robot 108 can operate. As depicted in FIG. 1, plurality of horizontal rails 106 can extend in a first direction proximate lifter frame 102 and away from lifter frame 102, for example, in two directions. In another embodiment (not shown), plurality of horizontal rails 106 can extend in a second direction transverse to the first direction, thereby allowing plurality of boxes 112 in stack 110 to be moved in the second direction. Plurality of horizontal rails 106 can extend from a stack 110 storage area to proximate the lifter frame 102 (sorting area), and between the storage and sorting areas such that the rail subsystem connects various areas of a warehouse as a basis for the movement of shuttle robot 108.

Shuttle robot 108 is a mobile transport vehicle configured to move on rails that are integrated into a warehouse racking structure. Accordingly, shuttle robot 108 can be operably coupled to plurality of horizontal rails 106 to move along rail subsystem. For example, shuttle robot 108 can include a drive mechanism for driving wheels for movement of shuttle robot 108.

Shuttle robot 108 is configured to transport stacks 110 and/or boxes 112 using plurality of horizontal rails and the shuttle robot 108 drive mechanism. In certain embodiments, shuttle robot 108 can change levels (e.g. ascend and descend) by means of vertical transporters or warehouse lifts. Shuttle robot 108 can store and retrieve stacks 110 and/or boxes 112 on several different levels. Double shifter sorting system 100 can comprise a plurality of shuttle robots 108, in embodiments.

Shuttle robot 108 is configured to be commanded via remote-control, radio signal or Wi-Fi, in embodiments. For example, an order or other similar instruction can be communicated via a signal to shuttle robot 108. In response to the instruction, shuttle robot 108 obtains stack 110, which includes goods for the order, and delivers it proximate lifter frame 102.

In an embodiment, shuttle robot 108 is configured to move between apertures 116a and 116b so as to shift boxes 112 between apertures 116a and 116b in coordination with the raising or lowering of lifter frame 102 according to a sorting algorithm.

In embodiments, lifter frame 102, plurality of vertical rails 104, and plurality of horizontal rails 106 can be made of a high-strength metal such as galvanized steel or other high-strength material, such as a composite material.

Accordingly, lifter frame 102 can be raised above a given stack 110 to a non-engaging position such that stack 110 can be passed by shuttle robot 108 underneath lifter frame 102 along plurality of horizontal rails 106. When shuttle robot 108 positions stack 110 proximate or underneath lifter frame 102, lifter frame 102 can be lowered to an engaging position to engage with one or more boxes 112.

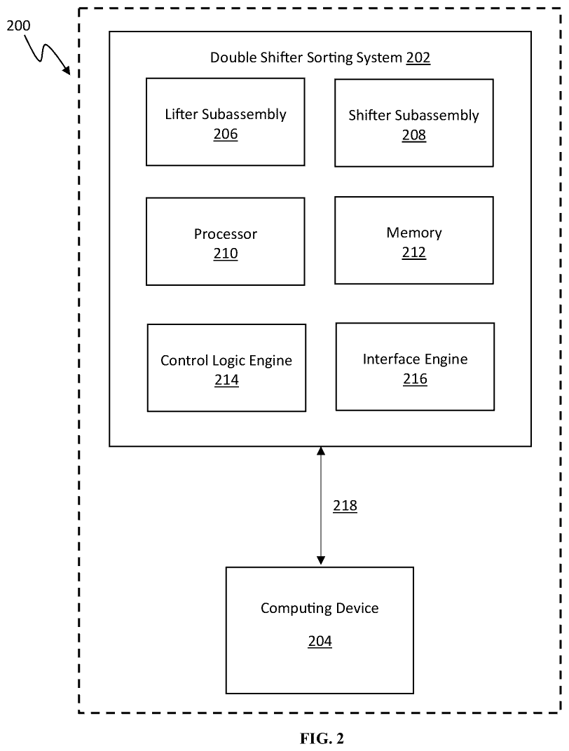

Referring also to FIG. 2, a block diagram of a warehouse management system 200 is depicted, according to an embodiment. Warehouse management system 200 generally comprises a double shifter sorting system 202 and a computing device 204.

Double shifter sorting system 202 generally comprises a lifter subassembly 206, a shifter subassembly 208, a processor 210, a memory 212, a control logic engine 214, and an interface engine 216.

Lifter subassembly 206 generally comprises mechanical components to physically raise and lower boxes in a stack in a generally vertical direction. For example, referring again to FIG. 1, lifter subassembly 206 can include lifter frame 102, plurality of vertical rails 104, and a drive mechanism to drive lifter frame 102 along at least one of plurality of vertical rails 104.

Shifter subassembly 208 generally comprises mechanical components to physically shift boxes in a stack in a generally horizontal direction. For example, referring again to FIG. 1, shifter subassembly 208 can include plurality of horizontal rails 106 and shuttle robot 108.

Processor 210 can be any programmable device that accepts digital data as input, is configured to process the input according to instructions or algorithms, and provides results as outputs. In an embodiment, processor 406 can be a central processing unit (CPU) configured to carry out the instructions of a computer program. Processor 210 is therefore configured to perform at least basic arithmetical, logical, and input/output operations.

Memory 212 can comprise volatile or non-volatile memory as required by the coupled processor 210 to not only provide space to execute the instructions or algorithms, but to provide the space to store the instructions themselves. In embodiments, volatile memory can include random access memory (RAM), dynamic random access memory (DRAM), or static random access memory (SRAM), for example. In embodiments, non-volatile memory can include read-only memory, flash memory, ferroelectric RAM, hard disk, floppy disk, magnetic tape, or optical disc storage, for example. The foregoing lists in no way limit the type of memory that can be used, as these embodiments are given only by way of example and are not intended to limit the scope of the invention.

Double shifter sorting system 202 includes various engines, each of which is constructed, programmed, configured, or otherwise adapted, to autonomously carry out a function or set of functions. The term engine as used herein is defined as a real-world device, component, or arrangement of components implemented using hardware, such as by an application specific integrated circuit (ASIC) or field-programmable gate array (FPGA), for example, or as a combination of hardware and software, such as by a microprocessor system and a set of program instructions that adapt the engine to implement the particular functionality, which (while being executed) transform the microprocessor system into a special-purpose device. An engine can also be implemented as a combination of the two, with certain functions facilitated by hardware alone, and other functions facilitated by a combination of hardware and software. In certain implementations, at least a portion, and in some cases, all, of an engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each engine can be realized in a variety of physically realizable configurations, and should generally not be limited to any particular implementation exemplified herein, unless such limitations are expressly called out. In addition, an engine can itself be composed of more than one sub-engines, each of which can be regarded as an engine in its own right. Moreover, in the embodiments described herein, each of the various engines corresponds to a defined autonomous functionality; however, it should be understood that in other contemplated embodiments, each functionality can be distributed to more than one engine. Likewise, in other contemplated embodiments, multiple defined functionalities may be implemented by a single engine that performs those multiple functions, possibly alongside other functions, or distributed differently among a set of engines than specifically illustrated in the examples herein. According to an embodiment, the engine components of double shifter sorting system 202 can be located relatively within a device associated with double shifter sorting system 202, in a singular “cloud” or network, or spread among many clouds or networks. End-user knowledge of the physical location and configuration of components of double shifter sorting system 202 is not required.

In particular, control logic engine 214 is configured to control the various components of lifter subassembly 206 and shifter subassembly 208. In particular, control logic engine 214 can coordinate commands to lifter subassembly 206 and shifter subassembly 208 to carry out stack manipulation.

Control logic engine 214 can comprise sorting algorithms. For example, control logic engine 214 receive any suitable data structure reflective of the stack to sort, and an indication of a target box in the data structure relative to the stack to sort. In an embodiment, control logic engine 214 can itself parse an instruction determine a suitable data structure and target box location in the data structure. For example, control logic engine 214 can be provided an array data structure and an array index corresponding to the target box location. In a stack 110 of five boxes, and a target box of the fourth box from the bottom, control logic engine 214 can be provided the following arguments:

Stack Array[5]; Target=3(assuming first box index=0);

Control logic engine 214 can utilize Stack Array[5] with another suitable data structure and corresponding sorting logic to place the target box on top of the stack. In an embodiment, Stack Array[5] corresponds to an initial position of boxes 112 relative to aperture 116a. Control logic engine 214 can implement a temporary array corresponding to aperture 116b (e.g. Temp Array[0]). Control logic engine 214 can therefore keep track of the physical location of boxes 112 in apertures 116a and 11b using corresponding data structures. Control logic engine 214 can implement a sorting algorithm by relative to a target box.

In an embodiment, control logic engine 214 can retrieve status information from the various components of double shifter sorting system 202. For example, control logic engine 214 can interface with lifter subassembly 206 to obtain the height location of lifter frame 102. In another example, control logic engine 214 can interface with shifter subassembly 208 to obtain the location of robot carrier 108 along horizontal rail 106.

Interface engine 216 is configured to interface with computing device 204. In an embodiment, interface engine 216 can receive instructions from computing device 204. For example, interface engine 216 can receive instructions from computing device 204 to sort and/or pick a given stack. Accordingly, interface engine 216 can receive information associated with one or more stacks that are or will be transported to lifter subassembly 206 (for example, via shifter subassembly 208). Such instructions can be communicated to control logic engine 214 to carry out stack manipulation. Interface engine 216 can parse or otherwise package computing device 204 instructions for control logic engine 214.

In an embodiment, interface engine 216 can further provide instructions or data to computing device 204. For example, interface engine 216 can provide a status or state information of the lifter subassembly 206 or shifter subassembly 208. In another example, interface engine 216 can provide stack status information as interpreted through control logic engine 214. In another example, interface engine 216 can provide instructions to computing device 204 to retrieve one or more stacks from the larger warehouse.

Computing device 204 can comprise a computing device integrated with overall warehouse management. For example, computing device 204 can be a desktop computer, laptop computer, tablet, or other computing device comprising software and processes that allows control and administration of warehouse operations from the time goods enter a warehouse until they move out.

In embodiments, warehouse management system 200 can be distributed such that all or portions of control logic engine 214 and associated controllers for lifter subassembly 206 and/or shifter subassembly 208 (as well as its own dedicated memory and processor) are integrated into computing device 204. In other embodiments, each subassembly or even components within a subassembly can include its own associated controller(s) as well as its own dedicated memory and processor as part of or discrete from a computing device of double shifter sorting system 202 and/or computing device 204.

In an embodiment, as depicted in FIG. 2, double shifter sorting system 202 is operably coupled to computing device 204 via one or more communication channels 218. Communication channel 218 can be wired or wireless and be implemented according to any suitable protocol, such as USB, BLUETOOTH, Internet Protocol (IP), Wi-Fi, or any other appropriate format for the respective data connection.

Accordingly, computing device 204 can interface with double shifter sorting system 202 to provide instructions to double shifter sorting system 202 (e.g. sort or pick instructions) and/or receive data from double shifter sorting system 202 (e.g. status information) over communication channel 218. In an embodiment, computing device 204 can communicate warehouse requests, such as order information from which product is to be retrieved, sort information, pick information, or retrieve status information.

In operation of warehouse management system 200, computing device 204 communicates a warehouse request to double shifter sorting system 202 via interface engine 216. Interface engine 216 receives the warehouse request. Depending on the request, interface engine 216 can parse or otherwise package or pass along the warehouse request to control logic engine 214. In embodiments, control logic engine 214 can determine which stacks and in which boxes the product is located.

Control logic engine 214 then instructs lifter subassembly 206 and shifter subassembly 208 to retrieve one or more stacks and manipulate the stacks according to the warehouse request. For example, control logic engine 214 can sort a given stack to retrieve a target box from the stack. The target box can be “picked” by manipulating the target box to the top of the stack to retrieve the goods inside the target box.

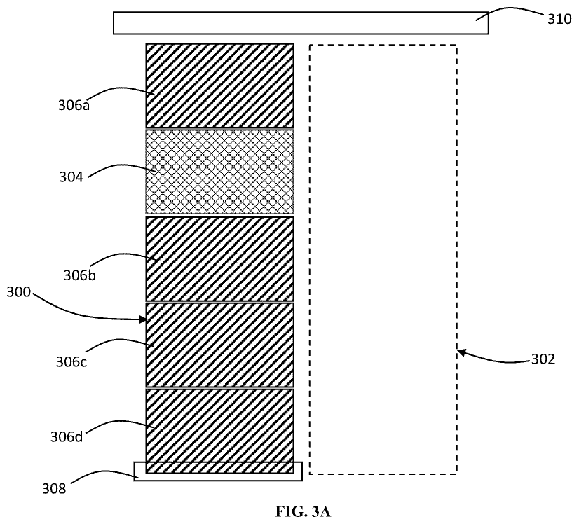

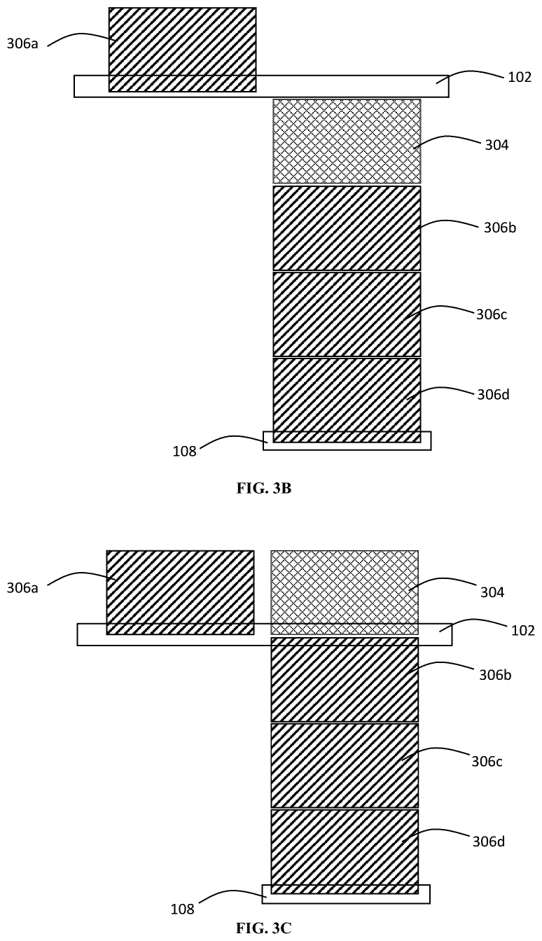

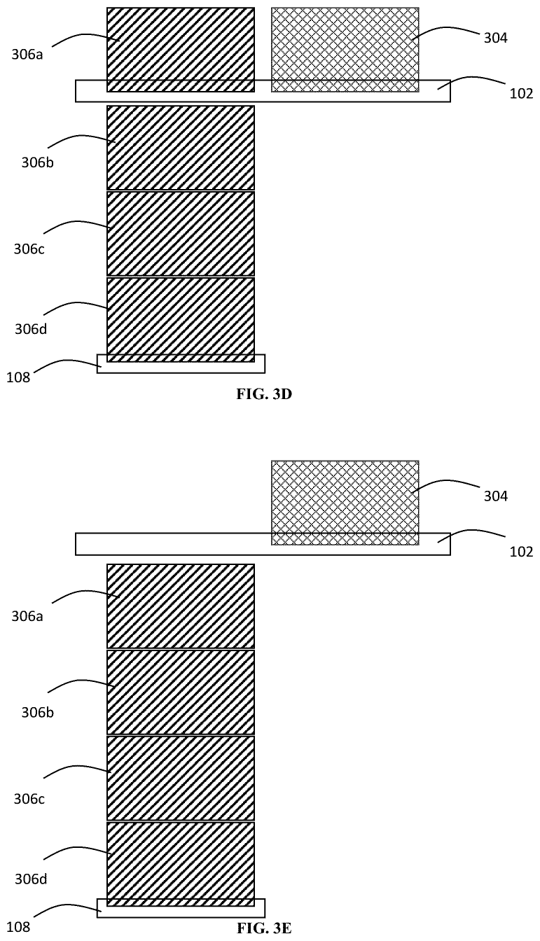

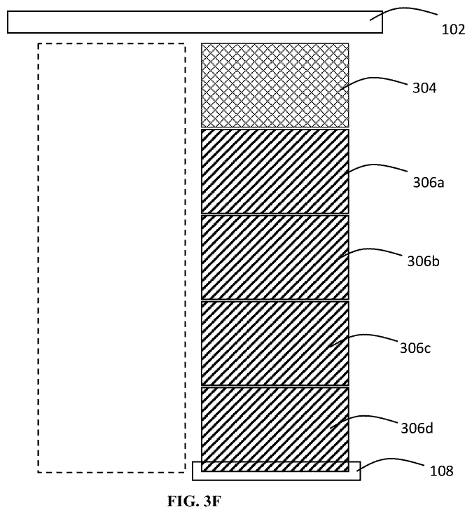

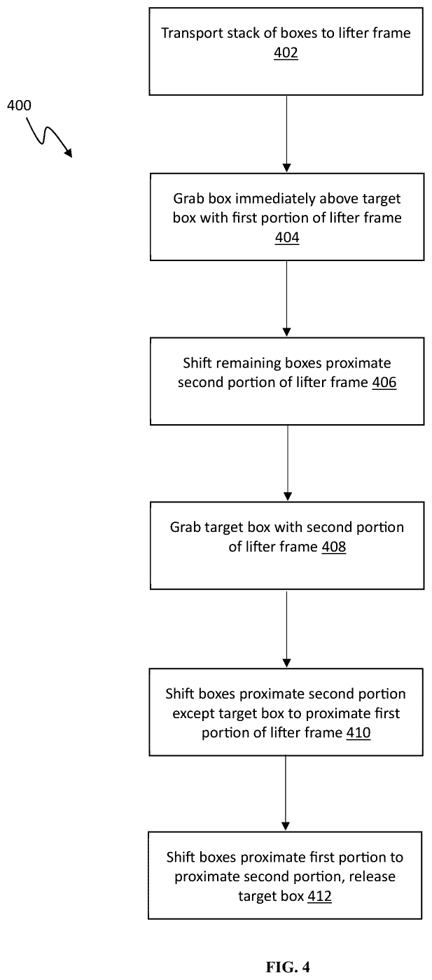

Referring to FIGS. 3A-3F, block diagrams of a stack sorted by a double shifter sorting system are depicted, according to an embodiment. For ease of explanation, further reference is made to FIG. 1 and double shifter sorting system 100. In an embodiment, a stack 300 of boxes can have an initial association with a first portion of lifter frame 102, such as first aperture 116a, and an empty stack 302 (e.g. a void where a box or stack can be positioned) can have an initial association with a second portion of lifter frame 102, such as second aperture 116b. As will be described, the stack 300 is sorted using the first portion and the second portion using coordination in lifting of lifter frame 102 and shifting of shuttle robot 108.

Referring to FIG. 3A, a stack 300 of boxes, such as a target box 304 and a plurality of other boxes 306 are depicted. Shuttle robot 108 can transport stack 300 proximate lifting frame 102 while lifting frame 102 is in a non-engaging position. For example, lifting frame 102 can be raised above the height of stack 300.

Referring to FIG. 3B, lifting frame 102 can be raised to engage with box 306a and allow the remaining boxes: target box 304, and other boxes 306b, 306c, and 306d to pass underneath lifting frame 102. Specifically, shuttle robot 108 can shift from under first aperture 116a to under second aperture 116b (previously empty stack 302). In embodiments, when box 306a is lifted, all additional boxes on top of box 306a are also lifted. Accordingly, when box 306a is engaged with lifting frame 102, any other boxes on top of box 306a are also engaged via the gravitational force between boxes.

Referring to FIG. 3C, lifting frame 102 can be lowered to a height appropriate to engage with target box 304. Target box 304 can then be grabbed.

Referring to FIG. 3D, lifting frame 102 can be raised to engage with target box 304 (as well as box 306a) and allow the remaining boxes 306b, 306c, and 306d to pass underneath lifting frame 102. Specifically, shuttle robot 108 can shift from under second aperture 116b to under first aperture 116a.

Referring to FIG. 3E, lifting frame 102 can be lowered to place box 306a onto box 306b and then disengage with box 306a. Subsequently, lifting frame 102 can be raised to allow boxes 306a, 306b, 306c, and 306d to pass underneath.

Referring to FIG. 3F, shuttle robot 108 can shift from under first aperture 116a to under second aperture 116b to move boxes 306a, 306b, 306c, and 306d. Lifting frame 102 can be lowered to place target box 304 onto box 306a and then disengage with box 306a. Subsequently, lifting frame 102 can be raised to allow target box 304 and boxes 306a, 306b, 306c, and 306d to pass underneath.

Referring to FIG. 4, a flowchart of a method 400 for sorting by a double shifter sorting system is depicted, according to an embodiment. Method 400 can be implemented by double shifter sorting system 100 and/or warehouse management system 200. For ease of explanation, further reference is made to FIG. 1 and double shifter sorting system 100.

When an order for certain goods is communicated to double shifter sorting system 100, double shifter sorting system 100 can determine in which stacks and in which box(es) the order is located.

At 402, a stack of boxes including at least one box having order goods (e.g. the target box) is transported to proximate lifter frame 102. For example, shuttle robot 108 can utilize plurality of horizontal rails 106 to move along plurality of horizontal rails 106 for ease of localization and to ensure accuracy of movement, drive under the desired stack 110 and transport stack 110 to proximate lifter frame 102. In an embodiment, when shuttle robot 108 transport stack 110 proximate lifter frame 102 lifter frame 102 is raised above stack 110 to a non-engaging position such that stack 110 can be positioned underneath lifter frame 102.

At 404, the box immediately above the target box is grabbed with the lifter frame. For example, lifter frame 102 is lowered using a drive mechanism operably coupled with lifter frame 102 and at least one of plurality of vertical rails 104 to drive lifter frame 102 along at least one of plurality of vertical rails 104 to a position to the box directly above the target box. In an embodiment, grooves integrated with at least one of plurality of vertical rails 104 can temporarily lock lifter frame 102 in place at the desired height. Utilizing appropriate grabbing elements and/or drop-down latches or lip elements on the boxes, lifter frame 102 lifts the box located directly above the target box. In an embodiment, lifter frame 102 uses a first portion (e.g. first aperture 116a) to lift the box above the target box.

At 406, the remaining boxes in stack 110 are shifted to under second aperture 116b, while at least one box in stack 110 is temporarily fixed in first aperture 116a. For example, shuttle robot 108 can shift the remaining boxes in stack 110 back to proximate a second portion (e.g. second aperture 116b).

At 408, lifter frame 102 is lowered just enough to grab the top box (now the target box). For example, lifter frame 102 is lowered using the drive mechanism operably coupled with lifter frame 102 and at least one of plurality of vertical rails 104 to drive lifter frame 102 along at least one of plurality of vertical rails 104 to a position to grab the target box.

At 410, the boxes positioned under second aperture 116b, except the target box, are shifted to under first aperture 116a. For example, shuttle robot 108 can return to under first aperture 116a. Further, the boxes temporarily fixed in first aperture 116a are loaded from above and by releasing of any clamp or other temporarily grabbing mechanism onto the remaining boxes in the stack under first aperture 116a. Lifter frame 102 can then be raised to a height above the top box in the stack.

At 412, the boxes under first aperture 116a are shifted to under second aperture 116b and the target box is placed on top of the resorted stack. For example, shuttle robot 108 moves under second aperture 116b, and lifter frame 102 lowers the target box with the desired product on the top of the stack.

Thus, the coordinated work of shuttle robot 108 together with lifter frame 102 allows for the preparation of a stack for the shipment of goods. In this case, the height of the occupied space is saved, because the work of double shifter sorting system 100 only requires slightly more height than for storing the stack (e.g. to lift a box from the top of another box to allow the remaining stack to shift relative to the lifted box). The minimum additional distance can depend on the height to which the box must be lifted from the stack in order to move the bottom of the stack from under the lifted box.

1. A system for sorting a vertically-stored stack of boxes, comprising:
a lifter subassembly including:
a lifting frame defining a first aperture and a second aperture, the lifting frame having a contiguous border surrounding the first aperture and the second aperture, each of first aperture and the second aperture configured to temporarily couple to a box in the stack of boxes, wherein the first aperture has a first aperture length and a first aperture width, wherein the second aperture has a second aperture length and a second aperture width, wherein the first aperture length is collinear with the second aperture length on the lifting frame, and wherein the first aperture width is parallel to the second aperture width on the lifting frame,
a plurality of vertical rails operably coupled to the lifting frame, and
a drive mechanism operably coupled to the lifting frame and the plurality of vertical rails and configured to drive the lifting frame along at least one of the plurality of vertical rails such that the first aperture and the second aperture move together; and
a shifter subassembly including:
a plurality of horizontal rails positioned below the lifting frame, and
a shuttle robot configured to transport the stack of boxes along the plurality of horizontal rails between the first aperture and the second aperture.

2. The system of claim 1, wherein when at least one box is temporarily coupled to the first aperture, the drive mechanism is further configured to raise the lifting frame above a remaining stack of boxes underneath the lifting frame, and the shuttle robot is further configured to transport the remaining stack of boxes underneath the lifting frame to below the second aperture.

3. The system of claim 1, wherein a first box in the stack of boxes is temporarily coupled to the first aperture while a second box in the stack of boxes is temporarily coupled to the second aperture.

4. The system of claim 1, wherein each box in the stack of boxes comprises a ledge that projects horizontally from a body of the box, wherein the lifting frame is configured to temporarily couple to the box using the ledge.

5. The system of claim 1, wherein the lifting frame further comprises a clamp, and the lifting frame is further configured to temporarily couple to the box using the clamp.

6. The system of claim 1, further comprising:
a processor and a memory operably coupled to the processor; and
a control logic engine executed by the processor and configured to sort the stack by:
lifting a first box immediately above a target box from the stack using the first aperture, the stack without the first box creating a first remaining stack,
shifting the first remaining stack to below the second aperture using the shuttle robot,
lifting the target box from the first remaining stack using the second aperture, the first remaining stack without the target box creating a second remaining stack,
shifting the second remaining stack to below the first aperture,
releasing the first box onto the second remaining stack, the first box added to the second remaining stack creating a third remaining stack,
shifting the third remaining stack to below the second aperture, and
releasing the target box onto the third remaining stack, the target box added to the third remaining stack creating a sorted stack.

7. The system of claim 6, wherein the control logic engine is further configured to raise the lifting frame above a stack height to allow the shuttle robot to shift the first remaining stack, shift the second remaining stack, and shift the third remaining stack underneath the lifting frame.

8. The system of claim 7, wherein the lifting frame is raised above the stack height at a minimum distance to avoid physical contact with the lifting frame and the first remaining stack, the second remaining stack, or the third remaining stack.

9. (canceled)

10. The system of claim 1, further comprising:
an interface engine executed by the processor and configured to receive a sorting instruction from a warehouse computing device.

11. A method of sorting a vertically-stored stack of boxes, the method comprising:
lifting a first box immediately above a target box from the stack of boxes using a first aperture of a lifting frame, the stack without the first box creating a first remaining stack, wherein the lifting frame has a contiguous border surrounding the first aperture and a second aperture, wherein the first aperture has a first aperture length and a first aperture width, wherein the second aperture has a second aperture length and a second aperture width, wherein the first aperture length is collinear with the second aperture length on the lifting frame, wherein the first aperture width is parallel to the second aperture width on the lifting frame, and wherein the first aperture and the second aperture move together;
shifting the first remaining stack to below the second aperture of the lifting frame using a shuttle robot;
lifting the target box from the first remaining stack using the second aperture, the first remaining stack without the target box creating a second remaining stack;
shifting the second remaining stack to below the first aperture;
releasing the first box onto the second remaining stack, the first box added to the second remaining stack creating a third remaining stack;
shifting the third remaining stack to below the second aperture; and
releasing the target box onto the third remaining stack, the target box added to the third remaining stack creating a sorted stack.

12. The method of claim 11, wherein lifting comprises driving the lifting frame along at least one of a plurality of vertical rails using a drive mechanism.

13. The method of claim 12, wherein at least one of the plurality of vertical rails includes at least one groove for the drive mechanism, the method further comprising temporarily locking the lifting frame in place using the at least one groove.

14. The method of claim 11, wherein shifting comprises transporting at least one box along a plurality of horizontal rails between the first aperture and the second aperture with the shuttle robot.

15. The method of claim 11, further comprising:
raising the lifting frame above a stack height to allow the shuttle robot to shift the first remaining stack, shift the second remaining stack, and shift the third remaining stack underneath the lifting frame.

16. The method of claim 11, wherein the lifting frame is raised above the stack height at a minimum distance to avoid physical contact with the lifting frame and the first remaining stack, the second remaining stack, or the third remaining stack.

17. The method of claim 11, further comprising:
receiving a sorting instruction from a warehouse computing device.

18. The method of claim 11, wherein each box in the stack of boxes comprises a ledge that projects horizontally from a body of the box, the method further comprising temporarily coupling the lifting frame to the box using the ledge.

19. The method of claim 18, wherein the lifting frame further comprises a clamp, the method further comprising temporarily coupling the lifting frame to the box using the ledge.

20. The method of claim 11, wherein lifting a first box immediately above a target box further includes lifting at least one additional box on top of the first box.

21. The system of claim 1, wherein the drive mechanism is operably coupled to only one of the plurality of vertical rails to drive the lifting frame.
